(19) United States
(12) Patent Application Publication
(10) Pub. No.: US 2008/0202163 A1
(43) Pub. Date: Aug. 28, 2008

(54) MATERIAL FOR HIGH REFRACTIVE INDEX GLASS, HIGH REFRACTIVE INDEX GLASS OBTAINED FROM THE MATERIAL, AND METHOD OF PATTERNING HIGH REFRACTIVE INDEX GLASS

(75) Inventors: Motoki Okinaka, Saitama (JP); Kazuhito Tsukagoshi, Saitama (JP); Yoshinobu Aoyagi, Saitama (JP); Yoshifumi Ichinose, Tokyo (JP); Toshiyuki Tachibana, Tokyo (JP); Hiroshi Tsushima, Osaka (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: RIKEN, Wako-shi (JP); NIPPON PAINT CO., LTD, Osaka (JP)

(21) Appl. No.: 11/845,623

(22) Filed: Aug. 27, 2007

(30) Foreign Application Priority Data
Feb. 27, 2007 (JP) 2007-046970

(51) Int. Cl. C03C 19/00; C03C 13/04

(52) U.S. Cl. 65/30.1; 501/37

(57) ABSTRACT

There is provided a material on which a minute pattern in nanometer order can be formed and capable of providing a glass having transparency and high refractive index. A material for a high refractive index glass according to an embodiment of the present invention includes a polysilane, a silicone compound, and metal oxide nanoparticles. Preferably, the polysilane includes a branched polysilane. Preferably, the polysilane and the silicone compound are contained at a weight ratio of 80:20 to 5:95. Preferably, the metal oxide nanoparticles are formed of at least one metal oxide selected from the group consisting of zircon oxide, titanium oxide, and zinc oxide.

This application claims priority under 35 U.S.C. Section 119 to Japanese Patent Application No. 2007-46970 filed on Feb. 27, 2007, which is herein incorporated by reference.

### BACKGROUND OF THE INVENTION

1. Field of the Invention

The present invention relates to a material for a high refractive index glass, a high refractive index glass obtained from the material, and a method of patterning a high refractive index glass.

2. Description of the Related Art

Various glasses have been finding applications in, for example, optics and ophthalmology. In recent years, a glass having a high refractive index has been desired in association with the expansion of those applications. However, a conventional SiO₂-based glass can not satisfy the need for the glass to have an increased refractive index.

Materials having various compositions such as Bi₄Ge₃O₁₂ and KTaO₃ have been developed as materials for high refractive index glasses. However, those materials involve a problem of being difficult to mold because of being brittle and having a high glass transition temperature.

Further, a high refractive index glass on which a minute pattern can be formed is demanded to allow the glass to be applied to various optical devices. At present, however, the material capable of sufficiently satisfying the demand has not been obtained.

“Nanoimprint of Glass Materials with Glassy Carbon Molds Fabricated by Focused-Ion-Beam Etching”, Masaharu Takahashi, Koichi Sugimoto and Ryutaro Maeda, Jpn. J. Appl. Phys., 44, 5600 (2005).

### SUMMARY OF THE INVENTION

The present invention has been made in order to solve the above-mentioned existing problems, and has an object to provide a glass having high hardness, transparent and high refractive index and on which a minute pattern in a nanometer order can be formed, and a material capable of providing such a glass.

A material for a high refractive index glass according to an embodiment of the present invention includes a polysilane, a silicone compound, and metal oxide nanoparticles.

In one embodiment of the invention, the polysilane includes a branched polysilane.

In another embodiment of the invention, the polysilane and the silicone compound are contained at a weight ratio of 80:20 to 5:95.

In still another embodiment of the invention, the metal oxide nanoparticles are formed of at least one metal oxide selected from the group consisting of zircon oxide, titanium oxide, and zinc oxide.

In still another embodiment of the invention, the metal oxide nanoparticles have an average particle diameter of 1 nm to 100 nm.

In still another embodiment of the invention, the metal oxide nanoparticles are contained at a ratio of 50 parts by weight to 500 parts by weight with respect to 100 parts by weight of the polysilane.

According to another aspect of the present invention, a high refractive index glass is provided. The high refractive index glass is obtained by oxidizing the material for a high refractive index glass as described above.

In one embodiment of the invention, the oxidation is performed by irradiating the material with an energy ray.

In another embodiment of the invention, the high refractive index glass has refractive index of 1.60 or higher, hardness of 120 HV or higher, and light transmittance in a visible region of 90% or higher.

According to still another aspect of the present invention, a method of forming a minute pattern on a high refractive index glass is provided. The method includes the steps of: applying, to a substrate, the material for a high refractive index glass as described above; pressing a mold on which a predetermined minute pattern has been formed to the material for a high refractive index glass which has been applied to the substrate; irradiating the material for a high refractive index glass with an energy ray from a side of the substrate while the mold is contacted by press with the material for a high refractive index glass; releasing the mold; and irradiating the material for a high refractive index glass with an energy ray from a side to which the mold has been pressed.

In one embodiment of the invention, the method further includes the step of irradiating oxygen plasma after the mold has been released.

In another embodiment of the invention, the step of pressing is performed at about room temperature.

In still another embodiment of the invention, the method further includes the step of heating the material for high refractive index glass material after irradiating the energy ray from the side to which the mold has been pressed.

In still another embodiment of the invention, the step of heating is performed at 150 to 450° C.

According to the present invention, there can be provided materials, which can provide a high hardness, high transparency, high refractive index glass on which a minute pattern in a nanometer order can be formed, by using a polysilane (preferably a branched polysilane), a silicone compound, and metal oxide nanoparticles in combination. Further, according to the present invention, a minute pattern can be formed on a glass simultaneously with the production of the glass by using the above-mentioned material and performing pressing and irradiation with an energy ray by a specific procedure. In addition, a period of time for a nanoimprint process can be significantly shortened because nanoimprinting can be performed at low temperature and low pressure within a short period of time. Further, the nanoimprint process is performed at low temperature, so the expansion and contraction of the minute pattern during transfer due to a temperature change are negligibly small, and hence the deformation of the minute pattern to be formed can be prevented in an extremely favorable manner.

### BRIEF DESCRIPTION OF THE DRAWINGS

In the accompanying drawings:

FIGS. 1A to 1E schematically illustrate a procedure of a method of forming a minute pattern according to a preferred embodiment of the present invention; and

FIGS. 2A to 2D schematically illustrate a chemical change of polysilane incorporated in a material for a high refractive index glass in the method of forming a minute pattern according to the preferred embodiment of the present invention.

### DETAILED DESCRIPTION OF THE PREFERRED EMBODIMENTS

### A. Material for High Refractive Index Glass

A material for a high refractive index glass of the present invention contains a polysilane, a silicone compound, and metal oxide nanoparticles. In general, the material for a high refractive index glass further contains a solvent. The material for a high refractive index glass can further contain any appropriate additive depending on a purpose. Typical examples of the additive include a sensitizer, a dispersant, and a surface active agent.

### A-1. Polysilane

In this specification, the term “polysilane” refers to a polymer having a main chain consisting of only silicon atoms. The polysilane used in the present invention may be a straight chain type or a branched type. A branched polysilane is preferable. This is because the branched polysilane is excellent in solubility and compatibility with respect to a solvent or a silicone compound, and is also excellent in a film formation property during a production of a glass. Polysilanes are classified into branched polysilanes and straight chain polysilanes depending on the bonding state of Si atoms incorporated in polysilanes. The branched polysilane refers to a polysilane which includes Si atoms in which the number of bonding to adjacent Si atoms is 3 or 4. In contrast, in a straight chain polysilane, the number of bonding in Si atoms is 2. Considering the fact that the valence of an Si atom is usually 4, the Si atoms whose bonding number is three or less among the Si atoms present in such a polysilane are bonded to a hydrogen atom or an organic substituent such as a hydrocarbon group and an alkoxy group in addition to an Si atom. Specific examples of preferable hydrocarbon groups include C₁₋₁₀ hydrocarbon groups which may be substituted with halogen and C₆₋₁₄ aromatic hydrocarbon groups which may be substituted with halogen. Specific examples of hydrocarbon groups include substituted or unsubstituted aliphatic hydrocarbon groups, such as a methyl group, an ethyl group, a propyl group, a butyl group, a hexyl group, an octyl group, a decyl group, a trifluoropropyl group, and a nonafluorohexyl group, and alicyclic hydrocarbon groups such as a cyclohexyl group and a methyl cyclohexyl group. Specific examples of aromatic hydrocarbon groups include a phenyl group, a p-tolyl group, abiphenyl group, and an anthracenyl group. Examples of an alkoxy group include C₁₋₈ alkoxy groups. Specific examples of C₁₋₈ alkoxy groups include a methoxy group, an ethoxy group, a phenoxy group, and an octyloxy group. Of those, in view of easiness in synthesis, a methyl group and a phenyl group are particularly preferable. For example, polymethylphenylsilane, polydimethylsilane, polydiphenylsilane, and a copolymer thereof can be preferably used. For example, the refractive index of a pattern or an optical element to be obtained can be adjusted by changing the structure of polysilane. Specifically, when a high refractive index is desired, a large amount of diphenyl groups may be incorporated during copolymerization, and when a low refractive index is desired, a large amount of dimethyl groups may be incorporated during copolymerization.

In branched polysilanes, the degree of branch is preferably 2% or more, more preferably 5 to 40%, and particularly preferably 10 to 30%. When the degree of branch is less than 2%, the solubility is low and microcrystals, which are likely to be generated in a film to be obtained, cause scattering, resulting in insufficient transparency in many cases. When the degree of branch is excessively high, polymerization of a polymer having large molecular weight may become difficult, and absorption in a visible region may become large due to the branching. In the above-mentioned preferable range, optical transmittance can be increased as the degree of branch is higher. In this specification, the phrase “the degree of branch” refers to a proportion of the Si atoms whose bonding number with adjacent Si atoms is 3 or 4 in all Si atoms of a branched polysilane. In this specification, for example, the phrase “the bonding number with adjacent Si atoms is 3” refers to a case where three bonding hands of an Si atom are bonded to Si atoms.

The polysilane used in the present invention can be produced by a polycondensation reaction in which a halogenated silane compound is heated to 80° C. or higher in an organic solvent such as n-decane or toluene in the presence of an alkaline metal such as sodium. Moreover, the polysilane used in the present invention can also be synthesized by an electrolytic polymerization method or a method using magnesium metal and metal chloride.

A branched polysilane is obtained by heating a halosilane mixture including an organotrihalosilane compound, a tetrahalosilane compound, and a diorganodihalosilane compound for polycondensation. The degree of branch of a branched polysilane can be controlled by adjusting the amount of the organotrihalosilane compound and the tetrahalosilane compound in the halosilane mixture. For example, by the use of ahalosilane mixture in which the proportion of an organotrihalosilane compound and a tetrahalosilane compound is 2 mol % or more with respect to the total amount, a branched polysilane whose degree of branch is 2% or more can be obtained. In such a case, an organotrihalosilane compound serves as a source of an Si atom whose bonding number with adjacent Si atoms is 3, and a tetrahalosilane compound serves as a source of an Si atom whose bonding number with adjacent Si atoms is 4. The branch structure of a branched polysilane can be confirmed by measuring an ultraviolet absorption spectrum or the nuclear magnetic resonance spectrum of silicon.

The halogen atom of each of the above-mentioned organotrihalosilane compound, tetrahalosilane compound, and diorganodihalosilane compound is preferably a chlorine atom. Examples of substituents other than the halogen atom of the organotrihalosilane compound and diorganodihalosilane compound include the above-mentioned hydrogen atom, hydrocarbon group, alkoxy group, and functional group.

There is no limitation on the above-mentioned branched polysilane insofar as they are soluble in an organic solvent, compatible with a silicone compound, and form a transparent film when being applied during a production of a glass.

The weight average molecular weight of the above-mentioned polysilane is preferably 5,000 to 50,000 and more preferably 10,000 to 20,000.

The above-mentioned polysilane may contain a silane oligomer, if required. The content of silane oligomer in the polysilane is preferably 5 to 25% by weight. By containing a silane oligomer in the above-mentioned range, a press contact process can be performed at lower temperature. When the oligomer content exceeds 25% by weight, flowage and disappearance of a pattern may occur in a heating process.

The weight average molecular weight of the above-mentioned silane oligomer is preferably 200 to 3,000 and more preferably 500 to 1,500.

### A-2. Silicone Compound

As a silicone compound used in the present invention, any appropriate silicone compound which is compatible with a polysilane and an organic solvent and which can form a transparent glass can be used. In one embodiment, a silicone compound is a compound represented by the following general formula:

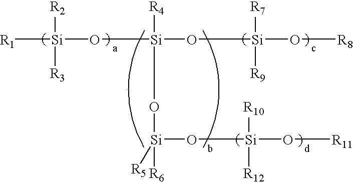

where R₁ to R₁₂ each independently represents C₁₋₁₀ hydrocarbon groups which may be substituted with a halogen or glycidyloxy group, C₆₋₁₂ aromatic hydrocarbon groups which may be substituted with a halogen or glycidyloxy group, or C₁₋₈ alkoxy groups which may be substituted with a halogen or glycidyloxy group, and a, b, c, and d are integers including 0 and satisfy a+b+c+d≧1.

A specific example thereof includes a silicone compound obtained by hydrolysis condensation of two or more kinds of dichlorosilane referred to as a D isomer, which has two organic substituents, and trichlorosilane referred to as T isomers, which has one organic substituent.

Specific examples of the hydrocarbon groups include substituted or unsubstituted aliphatic hydrocarbon groups such as a methyl group, a propyl group, a butyl group, a hexyl group, an octyl group, a decyl group, a trifluoropropyl group, and a glycidyloxypropyl group, and alicyclic hydrocarbon groups such as a cyclohexyl group and a methyl cyclohexyl group. Specific examples of the above-mentioned aromatic hydrocarbon groups include a phenyl group, a p-tolyl group, and a biphenyl group. Specific examples of the above-mentioned alkoxy groups include a methoxy group, an ethoxy group, a phenoxy group, an octyloxy group, and a tert-butoxy group.

The kinds of R₁ to R₁₂ and the values of a, b, c, and d may be appropriately determined depending on the purpose. For example, compatibility can be improved by incorporating, into a silicone compound, a group same as the hydrocarbon group incorporated in a polysilane. Therefore, when using, for example, a phenylmethyl polysilane as a polysilane, it is preferable to use a phenylmethyl silicone compound or a diphenyl silicone compound. Moreover, for example, a silicone compound which has two or more alkoxy groups in one molecule (specifically, a silicone compound in which at least two groups of R₁ to R₁₂ are C₁₋₈ alkoxy groups) can be used as a crosslinking agent. Specific examples of such a silicone compound include a methylphenyl methoxy silicone and phenylmethoxy silicone which include an alkoxy group in a proportion of 15 to 35% by weight. In this case, the content of the alkoxy group can be calculated from the average molecular weight of the silicone compound and the molecular weight of an alkoxy unit.

The weight average molecular weight of the above-mentioned silicone compound is preferably 100 to 10,000, and more preferably 100 to 3,000.

In one embodiment, a silicone compound contains, if required, a double bond-containing silicone compound. The content of the double bond-containing silicone compound in a silicone compound is preferably 20 to 100% by weight, and more preferably 50 to 100% by weight. By using a double bond-containing silicone compound in the above-mentioned range, the reactivity at the time of the irradiation of energy rays is improved, and press contact at lower temperature and processing at lower irradiation can be achieved. Moreover, when the content of a silicone compound is higher than that of a polysilane, flowage and disappearance of a pattern at the time of a heat treatment due to reduced solidity can be prevented.

The weight average molecular weight of the double bond-containing silicone compound is preferably 100 to 10,000, and more preferably 100 to 5,000.

A chemical group providing a double bond in the above-mentioned double bond-containing silicone compound is preferably a vinyl group, an allyl group, an acryloyl group, or a methacryloyl group. For example, among silicone compounds commonly referred to as a silane coupling agent, silicone compounds having a double bond can be used. In this case, the iodine value is preferably 10 to 254. The number of double bonds in one molecule of a silicone compound may be two or more. Such a silicone compound can be used as a crosslinking agent. Specific examples of such a silicone compound include a vinyl group-containing methylphenyl silicone resin which includes 1 to 30% by weight of a double bond.

A commercially available double bond-containing silicone compound can be used as the double bond-containing silicone compound. For example, compounds shown in the following Table 1 can be used.

TABLE 1

| Double | | | | |
|---|---|---|---|---|
| bond | Manufacturer | Tradename | Kind of silicone compound | Mw |
| Vinyl | Shinetsu Silicone | KBM-1003 | Vinyl trimethoxy silane | 148.2 |
| | Shinetsu Silicone | KBE-1003 | Vinyl triethoxy silane | 190.3 |
| | Shinetsu Silicone | KR-2020 | Vinyl group-containing phenylmethyl | 2,900 |
| | | | silicone resin | |
| | Shinetsu Silicone | X-40-2667 | Vinyl group-containing phenylmethyl | 2,600 |
| | | | silicone resin | |
| | Dow Corning Toray | SZ-6300 | Vinyl trimethoxy silane | |
| | Dow Corning Toray | SZ-6075 | Vinyl triacethoxy silane | |
| | Dow Corning Toray | CY52-162 | Vinyl group containing silicone resin | |
| | Dow Corning Toray | CY52-190 | Vinyl group containing silicone resin | |
| | Dow Corning Toray | CY52-276 | Vinyl group containing silicone resin | |
| | Dow Corning Toray | CY52-205 | Vinyl group containing silicone resin | |
| | Dow Corning Toray | SE1885 | Vinyl group containing silicone resin | |
| | Dow Corning Toray | SE1886 | Vinyl group containing silicone resin | |
| | Dow Corning Toray | SR-7010 | Vinyl group-containing phenylmethyl | |
| | | | silicone resin | |
| | GE Toshiba Silicone | TSL8310 | Vinyl trimethoxy silane | |
| | GE Toshiba Silicone | TSL8311 | Vinyl triethoxy silane | |
| | GE Toshiba Silicone | XE5844 | Vinyl group-containing phenylmethyl | |
| | | | silicone resin | |
| Methacryloyl | Shinetsu Silicone | KBM-502 | 3-methacryloxypropylmethyldimethoxy | 232.4 |
| | | | silane | |
| | Shinetsu Silicone | KBM-503 | 3-methacryloxypropyltrimethoxy | 248.4 |
| | | | silane | |
| | Shinetsu Silicone | KBE-502 | 3-methacryloxypropylmethyldiethoxy | 260.4 |
| | | | silane | |
| | Shinetsu Silicone | KBE-503 | 3-methacryloxypropyltriethoxy | 290.4 |
| | | | silane | |
| | GE Toshiba Silicone | SZ-6030 | γ-methacryloxypropyltrimethoxy | |
| | | | silane | |
| | GE Toshiba Silicone | TSL8370 | γ-methacryloxypropyltrimethoxy | |
| | | | silane | |
| | GE Toshiba Silicone | TSL8375 | γ-methacryloxypropylmethyldimethoxy | |
| | | | silane | |
| Acryloyl | Shinetsu Silicone | KBM-5103 | 3-acryloxypropyltrimethoxy silane | 234.3 |

The above-mentioned silicone compound(s) is incorporated in a material for a high refractive index glass in such a manner that the weight ratio of polysilane to silicone compound is preferably 80:20 to 5:95, and more preferably 70:30 to 40:60. By containing the silicone compound(s) in the above-mentioned range, a film mold which is sufficiently cured (i.e., notably excellent in hardness), which has very few cracks, and which has high transparency can be obtained during the production of the glass.

### A-3. Metal Oxide Nanoparticles

As the metal oxide nanoparticles, any appropriate nanoparticles may be used insofar as the effect of the present invention can be achieved. Specific examples of metals which form a metal oxide include lithium (Li), copper (Cu), zinc (Zn), strontium (Sr), barium (Ba), aluminum (Al), yttrium (Y), indium (In), cerium (Ce), silicon (Si), titanium (Ti), zirconium (Zr), tin (Sn), niobium (Nb), antimony (Sb), tantalum (Ta), bismuth (Bi), chromium (Cr), tungsten (W), manganese (Mn), iron (Fe), nickel (Ni), ruthenium (Ru), and alloys thereof. The composition of oxygen in a metal oxide is determined according to the valence of metal. In the present invention, zircon oxide, titanium oxide, and/or zinc oxide may be preferably used as a metal oxide. By using such metal oxide, a glass having desired refractive index and excellent transparency can be obtained. Furthermore, a glass having remarkably high hardness can be obtained.

The average particle diameter of the above-mentioned metal oxide nanoparticles is preferably 1 to 100 nm, and more preferably 1 to 50 nm. By using the metal oxide nanoparticles having average particle diameter in the above-mentioned range, a glass having extremely excellent hardness and transparency can be obtained.

The above-mentioned metal oxide nanoparticles are contained in a material for a high refractive index glass in a proportion of preferably 50 to 500 parts by weight, and more preferably 100 to 300 parts by weight with respect to 100 parts by weight of the above-mentioned polysilane. By containing metal oxide nanoparticles in the above-mentioned range, a glass with desired refractive index can be obtained, and also such a glass has outstanding film formation properties at the time of manufacturing and/or pattern formation.

The above-mentioned metal oxide nanoparticles can be obtained using any appropriate methods. For example, the above-mentioned metal oxide nanoparticles can be formed by wet process, burning process, etc. Moreover, commercially available metal oxide nanoparticles may be used as the above-mentioned metal oxide nanoparticles. A specific example of commercially available metal oxide nanoparticles includes nano zirconia dispersion NZD-8J61 (tradename) manufactured by Sumitomo Osaka Cement Co., Ltd.

Metal oxide nanoparticles are provided in the form of dispersion in one embodiment. In this case, typically, a material for a high refractive index glass may be prepared by adding, under stirring, another ingredient described later, to a dispersion of metal oxide nanoparticles. In another embodiment, metal oxide nanoparticles may be provided in non-dispersed form (substantially in the form of particles). In this case, metal oxide nanoparticles are dispersed in another ingredient of a material for a glass, and the solid content of the material for a glass can be adjusted using a solvent and the like to be described later. In each embodiment, a dispersant is suitably used. The dispersant will be described in the section A-6 below.

### A-4. Solvent

The above-mentioned material for a high refractive index glass generally contains a solvent. An organic solvent is preferable as a solvent. Preferable organic solvents include C₅₋₁₂ hydrocarbon solvents, halogenated hydrocarbon solvents, and ether solvents. Specific examples of hydrocarbon solvents include: aliphatic solvents such as pentane, hexane, heptane, cyclohexane, n-decane, and n-dodecane; and aromatic solvents such as benzene, toluene, xylene, and methoxy benzene. Specific examples of halogenated hydrocarbon solvents include carbon tetrachloride, chloroform, 1,2-dichloro ethane, dichloromethane, and chlorobenzene. Specific examples of ether solvents include diethyl ether, dibutyl ether, and tetrahydrofuran. The amount of the solvent used is adjusted in such a manner that the polysilane concentration in a material for a high refractive index glass is in the range of 10 to 50% by weight.

### A-5. Sensitizer

Preferably, the above-mentioned material for a high refractive index glass may further contain a sensitizer. A typical example of a sensitizer includes an organic peroxide. Any compounds, which can efficiently incorporate oxygen between an Si—Si bond of a polysilane, can be employed as the organic peroxides. Examples thereof include a peroxyester peroxide and an organic peroxide having a benzophenone structure. More specifically, 3,3′,4,4′-tetra(tert-butylperoxycarbonyl)benzophenone (hereinafter, referred to as “BTTB”) is used preferably. Moreover, an organic peroxide acts on a double bond of a double bond-containing silicone compound to promote an addition polymerization reaction between double bonds.

The above-mentioned sensitizer is used in a proportion of preferably 1 to 30 parts by weight, and more preferably 2 to 10 parts by weight with respect to a total amount of 100 parts by weight of the above-mentioned polysilane and silicone compound. By using a sensitizer in the above-mentioned range, oxidation of a polysilane is promoted even under a non-oxidative atmosphere, and a high refractive index glass having remarkably excellent hardness can be formed at high production efficiency.

A-6. Other additives

Any appropriate dispersant can be adopted as the above dispersant as long as the effect of the present invention can be obtained. For example, any one of the following dispersants (1) to (3) can be suitably used: (1) a comb-shaped-polymer having a group affinitive to a metal oxide nanoparticle on at least one of its main chain and each of its multiple side chains, and having multiple side chains constituting a solvated portion for solvent; (2) a polymer having a group affinitive to a metal oxide nanoparticle in its main chain; and (3) a linear polymer having a group affinitive to a metal oxide nanoparticle at one terminal of its main chain.

Here, the above group affinitive to a metal oxide nanoparticle refers to a functional group having a strong adsorbability with respect to the surface of a metal oxide nanoparticle, and examples of the group include a tertiary amino group, quaternary ammonium, a heterocyclic group having a basic nitrogen atom, a hydroxyl group, a carboxyl group, a phenyl group, a lauryl group, a stearyl group, a dodecyl group, and an oleyl group. In the present invention, the above group affinitive to a metal oxide nanoparticle shows a strong affinity for a metal oxide surface. The above polymer dispersant can exert sufficient performance as a protective colloid for a metal oxide nanoparticle because the dispersant has the above group affinitive to a metal oxide nanoparticle. The above polymer dispersant may be a low-polar dispersant or a polar dispersant; the dispersant is preferably a low-polar dispersant because a nonaqueous organic solvent is used in the present invention.

Typical examples of the commercially available products of the low-polar polymer dispersant include: Disperbyk 110, Disperbyk LP-6347, Disperbyk 170, Disperbyk 171, Disperbyk 174, Disperbyk 160, Disperbyk 162, Disperbyk 163, Disperbyk 164, Disperbyk 161, Disperbyk 166, Disperbyk 168, Disperbyk 182, Disperbyk 2000, Disperbyk 2001, Disperbyk 2050, Disperbyk 2150, Disperbyk 2070, Disperbyk P104, Disperbyk P104S, Disperbyk 220S (manufactured by BYK Japan KK); Solsperse 24000, Solsperse 28000, Solsperse 32500, Solsperse 32550, Solsperse 32600, Solsperse 31845, Solsperse 26000, Solsperse 36600, Solsperse 37500, Solsperse 35100, Solsperse 38500 (manufactured by The Lubrizol Corporation); EFKA-1101, EFKA-1120, EFKA-1125, EFKA-4046, EFKA-4047, EFKA-4080, EFKA-4050, EFKA-4055, EFKA-4008, EFKA-4009, EFKA-4010, EFKA-4015, EFKA-4400, EFKA-4401, EFKA-4402, EFKA-4403, EFKA-4020 (manufactured by EFKA Additives); Flowlen D-90, Flowlen G-700, Flowlen G-820, Flowlen G-600, Flowlen DOPA-15B, Flowlen DOPA-17, Flowlen DOPA-22, Flowlen DOPA-33, Flowlen DOPA-44, Flowlen NC-500, Flowlen TG-710 (manufactured by KYOEISHA CHEMICAL Co., LTD); Disparion 2150, Disparion 1210 (manufactured by Kusumoto Chemicals, Ltd.); and Ajisper PB711, Ajisper PA111, Ajisper PB821, Ajisper PB822, Ajisper PN411 (manufactured by Ajinomoto Fine-Techno. Co. Inc).

The above dispersant can be used at a ratio of preferably 10 parts by weight to 100 parts by weight with respect to 100 parts by weight of the polysilane. The use of the dispersant enables the above metal oxide nanoparticles to be uniformly dispersed, whereby a glass having excellent transparency can be obtained.

Specific examples of the above surface active agent include fluorine-based surfactants. The surface active agent can be used at a ratio of preferably 0.01 part by weight to 0.5 part by weight with respect to 100 parts by weight of the total of the polysilane and the silicone compound described above. The use of the surface active agent can improve the coating property of the material for a high refractive index glass.

### B. High Refractive Index Glass

A high refractive index glass of the present invention can be obtained by oxidizing the material for a high refractive index glass described in the above section A. That is, the high refractive index glass of the present invention has a silicon dioxide skeleton formed by the oxidation of the polysilane in the above material for a high refractive index glass. The oxidation is preferably performed by irradiating the material with an energy ray (for example, light such as visible light, infrared light, or ultraviolet light, an electron beam, or heat). To be more specific, the high refractive index glass of the present invention is obtained by: applying, to a predetermined substrate, the material for a high refractive index glass described in the above section A; pressing a mold having a predetermined shape to the applied film as required; and irradiating the applied film with an energy ray (such as ultraviolet light) in a state where the mold is contacted by press with the applied film. Therefore, in one embodiment, a minute pattern can be formed on the high refractive index glass simultaneously with the production of the glass by using a predetermined mold. A method of forming a minute pattern will be described in the following section C. Detailed conditions for, for example, oxidation necessary for the formation of a high refractive index glass will also be described in the section C because the conditions are identical to those in the case of the method of forming a minute pattern.

The refractive index of the above high refractive index glass is preferably 1.60 or higher, and more preferably 1.8 or higher. The refractive index can be measured by any appropriate method (such as reflectance spectroscopy, an ellipsometry method, or a prism coupler method). Further, the hardness of the above high refractive index glass is preferably 120 HV or more, more preferably 140 HV or higher, and still more preferably 200 HV or higher. In addition, the light transmittance of the above high refractive index glass is preferably 90% or higher, and more preferably 95% or higher in a visible region. The use of the material for a high refractive index glass of the present invention can provide a glass simultaneously satisfying such excellent characteristics simply and at a low cost.

### C. Method of Forming a Minute Pattern

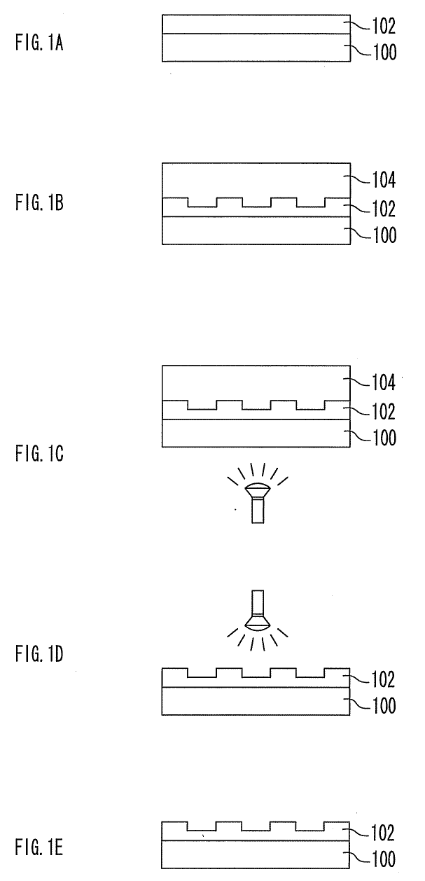

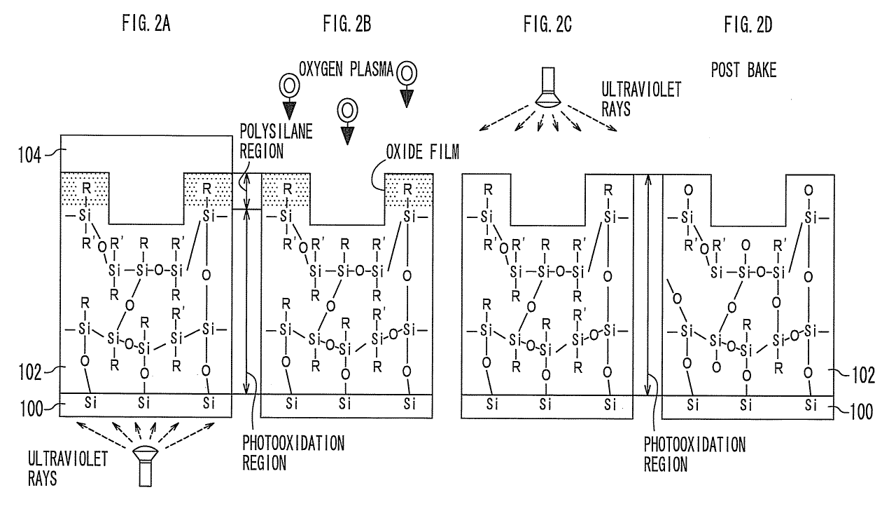

As described above, in one embodiment of the present invention, a minute pattern can be formed on the high refractive index glass simultaneously with the production of the glass. Hereinafter, with reference to the drawings, a method of forming a minute pattern according to an embodiment of the present invention will be described. FIGS. 1A to 1E schematically illustrate a procedure of a method of forming a minute pattern according to a preferred embodiment of the present invention. FIGS. 2A to 2D schematically illustrate the chemical change of a polysilane incorporated in a material for a high refractive index glass.

First, as shown in FIG. 1A, a material for a high refractive index glass 102 described in the section A above is applied to a substrate 100. As a substrate, any appropriate substrate through which energy rays can pass may be used. A typical example of a substrate includes a quartz substrate in the case of using ultraviolet rays as energy rays. Any appropriate coating method may be adopted as a method for the coating of a material for a high refractive index glass. Spin coating is mentioned as a typical example. The coating thickness of a material for a high refractive index glass may be appropriately set in accordance with the purpose. In the case where a minute pattern is formed simultaneously with the production of the glass, the coating thickness is preferably larger than the height of a minute pattern part of a mold. For example, when the height of the minute pattern part of the mold is 1.0 μm, the coating thickness of the material for a high refractive index glass is preferably about 1.1 to about 2.0 μm. The coating thickness of the material for a high refractive index glass can be controlled by adjusting the concentration of the material for a high refractive index glass and the speed of rotation (rpm) of a spin coater.

Next, as shown in FIG. 1B, a mold 104 on which a predetermined minute pattern has been formed depending on the purpose is contacted by press with the material for a high refractive index glass 102 which has been applied to the substrate 100. In one embodiment, press contact (also referred to as “pressing” in this specification) is preferably performed at about room temperature. In another embodiment, press contact is preferably performed in the range of room temperature to 80° C. Press contact at such a low temperature can be achieved by using the above-mentioned material for a high refractive index glass and performing a series of processes to be described later. Because the press contact at such a low temperature can shorten a period of time required for raising a temperature and lowering a temperature, processing time of a nanoimprint process (specifically, a pattern transfer process of a mold) can be dramatically reduced. Further, the merit of press contact at about room temperature resides in that because expansion and contraction of the material (e.g., a mold, a substrate, a material for a high refractive index glass and the like) due to temperature changes becomes so small that they can be ignored, thermal deformation of the minute pattern during transferring can be favorably avoided. It is one of the achievements of the present invention that such press contact at a low temperature is realized. In one embodiment, press contact temperature is in the range of 60° C. to 80° C., contact pressure is 3 MPa to 5 MPa, and a press contact time is 5 seconds to 120 seconds. According to the present invention, nanoimprint at low temperatures and low pressures, and in a short period of time as described above becomes possible. In the present invention, it is desirable that a material for a high refractive index glass be heat-treated before press contact (a so-called prebaking treatment). As conditions for the prebaking treatment, a heating temperature is 50 to 100° C., and a heating duration is 3 to 7 minutes, for example.

The above-mentioned mold 104 is preferably formed of an energy ray transmittable material, and is more preferably formed of a light transmittable material for alignment of a mold and a lower substrate. A specific example of a material which forms a mold includes quartz glass or an Si substrate having excellent processability.

Next, as shown in FIG. 1C, under a state where the mold 104 and the material for a high refractive index glass 102 are contacted by press, energy rays (typically ultraviolet rays to be described later) are irradiated. As a result, an Si—Si bond in a polysilane in the material for a high refractive index glass is converted into an Si—O—Si bond, thereby vitrifying the material for a high refractive index glass. Energy rays are irradiated from the substrate 100 side. By performing the energy ray irradiation from the substrate 100 side, oxidation (typically photooxidation) of the entire material for a high refractive index glass can be advanced until the mold pattern is firmly fixed as shown in FIG. 2A. Moreover, when using, for example, a quartz substrate, regarding the material for a high refractive index glass in the vicinity of the substrate 100, an Si—O—Si bond is also formed between Si atoms of the substrate and the material for a high refractive index glass, and therefore very firm adherence can be achieved. As shown in FIG. 2A, by selecting an appropriate light irradiation amount for the material for a high refractive index glass in the vicinity of the mold 104, progress of oxidation (typically photooxidation) can be inhibited and an outstanding mold-release property between the mold and the material for a high refractive index glass can be secured. As a result of leaving a portion which is not photo-oxidized at the interface between the mold and the material for a high refractive index glass, the mold and the material for a high refractive index glass are not adhered to each other and the material for a high refractive index glass can be released from the mold. Therefore, a high refractive index glass having a minute pattern can be formed with a very high yield.

As described above, typical examples of the energy rays include light (visible light, infrared rays, ultraviolet rays), electron beam, and heat. Ultraviolet rays are preferable in the present invention. Ultraviolet rays those wavelength spectrum peak is 365 nm or less are preferable. Specific examples of a source of ultraviolet rays include an ultra-high pressure mercury lamp and a halogen lamp. In one embodiment, when the coating thickness of a material for a high refractive index glass is about 2 μm, the material for a high refractive index glass is irradiated with ultraviolet rays those horizontal emission intensity is 105 μW/cm (wavelength λ=360 nm to 370 nm) for about 3 minutes, thereby vitrification of the material for a high refractive index glass can be performed.

Next, the mold 104 is released from the material for a high refractive index glass 102. As described above, because the oxidation of the material for a high refractive index glass in the vicinity of the mold is inhibited moderately, release of the mold is very easy. Therefore, pattern missing at the time of mold releasing and fall of the yield can be notably inhibited. In addition, as shown in FIG. 1D, when the mold is released, the minute pattern is formed sufficiently favorably in terms of appearance.

As required, the material for a high refractive index glass (apparently, a high refractive index glass) 102 having a minute pattern formed thereon may be irradiated with oxygen plasma. By the irradiation of oxygen plasma, a sufficient amount of oxygen is supplied to the surface of a material for a high refractive index glass, which has not been completely oxidized. As a result, as shown in FIG. 2B, a hard oxide film is formed on the surface. Thus, deformation of the formed minute pattern is favorably avoided. The thickness of the oxide film formed by plasma treatment is 2 to 3 nm, for example. The irradiation conditions of oxygen plasma are, for example, as follows: oxygen flow of 800 cc, chamber pressure of 10 Pa, irradiation time of 1 minute, and output of 400 W.

Next, as shown in FIG. 1D, the material for a high refractive index glass (apparently, a high refractive index glass) 102 having a minute pattern formed thereon is irradiated with energy rays (typically ultraviolet rays) from the side opposite to the substrate 100 (i.e., side to which the mold 104 has been contacted by press). By the irradiation of ultraviolet rays, photooxidation of the material for a high refractive index glass in the vicinity of the patterned surface is completed substantially, and the surface of the pattern is sufficiently oxidized (refer to FIG. 2C). In one embodiment, ultraviolet rays may be irradiated in the presence of ozone. By irradiating ultraviolet rays in the presence of ozone, not only that photooxidation reaction caused by the irradiation of ultraviolet rays can be progressed but also the chemical oxidation reaction caused by ozone can be progressed. Thus, oxidation of an unreacted portion of the pattern surface can be favorably completed.

Preferably, after the irradiation of energy rays from the mold side described above, a heat-treatment (a so-called post bake process) can be further performed. By performing a post bake process, oxidation reaction of a polysilane due to heat (thermal oxidation) occurs in addition to the above-mentioned oxidation reaction (photooxidation) of a polysilane by the irradiation of ultraviolet rays. As a result, oxidation of a polysilane is further progressed and a glass having extremely excellent hardness is obtained (refer to FIGS. 1E and 2D). In one embodiment, the conditions of the post bake process are as follows: a heating temperature being preferably 150 to 450° C. and heating duration being 3 to 10 minutes. The heating temperature may vary depending on the purpose. For example, chemical resistance may be imparted to the high refractive index glass to be obtained by post baking at 150 to 200° C. It is one of the achievements of the present invention to realize such a post bake process at significantly low temperatures compared to conventional post bake process (for example, at 350° C. or more). Moreover, by post baking at 400° C., for example, a high refractive index glass which has a Vickers hardness comparable to low-melting point glass can be obtained.

As described above, a minute pattern can be formed on the high refractive index glass simultaneously with the production of the glass. In the case of only producing a high refractive index glass (for example, producing a thin plate-shaped high refractive index glass), since it is not necessary to consider prevention of pattern missing or the like, the irradiation position of the ultraviolet rays or the irradiation order needs not to be specified. The oxygen plasma treatment for preventing deformation of the pattern is not required either. In the case where the hardness is desired, the material for a high refractive index glass may be heat-treated at an appropriate temperature.

### D. Applications of High Refractive Index Glass

The high refractive index glass of the present invention can be suitably utilized in, for example, an optical device such as a photonic crystal, a microlens, or a grating, a replica mold for nanoimprinting, or a display.

Hereinafter, the present invention will be described in more detail by way of examples. However, the present invention is not limited thereto. It should be noted that the term “%” and the term “part(s)” in each example refer to “wt %” and “part(s) by weight”, respectively unless otherwise stated. In addition, evaluation items in each example are as described below.

### (1) Refractive Index

A refractive index at a wavelength of 632 nm was determined with a measuring machine adopting biaxial reflectance spectroscopy (Film Tek 4000 manufactured by SCI).

### (2) Transparency

A light transmittance was measured by an ordinary method. The case where a light transmittance in a visible region was 90% or higher was defined as a “good” case, the case where the light transmittance was 70% or higher and less than 90% was defined as a “moderate” case, and the case where the light transmittance was less than 70% was defined as a “bad” case.

### (3) Hardness

A microvickers hardness was measured and evaluated.

### (4) Minute Pattern Formability

A minute pattern formed on a glass was observed with a scanning electron microscope (SEM). The case where the pattern of a mold used in the formation of the minute pattern was faithfully transferred was defined as a “good” case, the case where a slight difference between the pattern of the mold and the formed minute pattern was acknowledged was defined as a “moderate” case, and the case where a pattern could not be acknowledged was defined as a “bad” case.

### (5) Surface Roughness

The surface state of an obtained glass was measured with a surface roughness meter. The case where a surface roughness Ra was 1 nm or less was defined as a “good” case, the case where the surface roughness Ra was more than 1 nm and 5 nm or less was defined as a “moderate” case, and the case where the surface roughness Ra was more than 5 nm was defined as a “bad” case.

### (6) Heat Resistance

A glass on which a minute pattern had been formed was heated on a hot plate, and a ratio of the height of the pattern after a heat treatment at 350° C. for 5 minutes to the height of the pattern before the heat treatment was used as an indicator for heat resistance. The case where the height ratio was 0.90 or higher was defined as a “good” case, the case where the height ratio was 0.7 or higher and less than 0.9 was defined as a “moderate” case, and the case where the height ratio was less than 0.7 was defined as a “bad” case.

### (7) Chemical Resistance

A glass on which a minute pattern had been formed was subjected to ultrasonic cleaning in acetone for 5 minutes, and the states of a pattern shape before and after the cleaning were observed. The case where the pattern shape before the cleaning was maintained after the cleaning was defined as a “good” case, and the case where the pattern disappeared was defined as a “bad” case. In addition, the resultant pattern was immersed in each of a 10% aqueous solution of HCl, a 10% aqueous solution of NaOH, and a 5% aqueous solution of HF for 30 minutes, and the states of the pattern shape before and after the immersion were observed. The case where the pattern shape before the immersion was maintained after the immersion was defined as a “good” case, and the case where the pattern disappeared was defined as a “bad” case.

### REFERENCE EXAMPLE 1

### Synthesis of a Polysilane

Four hundred ml of toluene and 13.3 g of sodium were charged in a 1000-ml flask equipped with a stirrer. The temperature of the contents of this flask was raised to 111° C. and stirred at high speed in a yellow room which shielded ultraviolet rays, thereby finely dispersing sodium in toluene. Phenylmethyldichlorosilane 42.1 g and 4.1 g of tetrachlorosilane were added thereto, followed by stirring for 3 hours for polymerization. Then, ethanol was added to the reaction mixture obtained to deactivate excessive sodium. The resultant was washed with water, and then the separated organic layer was put in ethanol to thereby precipitate a polysilane. By re-precipitating the obtained crude polysilane 3 times in ethanol, a branched polymethylphenylsilane having weight average molecular weight of 11,600 and including 10% of oligomer was obtained.

### EXAMPLE 1

### Preparation of Material for High Refractive Index Glass

First, 30.14 parts of polymethylphenylsilane (PMPS) obtained in Reference Example 1 and 22.27 parts of a sensitizer (organic peroxide BTTB, manufactured by NOF CORPORATION) were dissolved in 31.98 parts of methoxybenzene (trade name “Anisole-S”, manufactured by KYOWA HAKKO CHEMICAL CO., LTD.). Next, 15.08 parts of a methoxy group-containing phenylmethylsilicone resin having no double bond (trade name “DC-3074”, manufactured by Dow Corning Corporation) and 0.54 part of a surface active agent (manufactured by DAINIPPON INK AND CHEMICALS, INCORPORATED, R08, 50% anisole solution) were added to the solution, and, furthermore, methoxybenzene was added to the mixture to adjust a solid content to 50%.

Then, 100 parts of the composition obtained in the foregoing were gradually added to 420.2 parts of a zircon oxide nanoparticle dispersion (manufactured by SUMITOMO OSAKA CEMENT Co., Ltd., trade name NZD-8J61, solid content 16%) while being stirred, whereby a material for a high refractive index glass was prepared. In this case, the amount of zircon oxide used was 142.2 parts with respect to 100 parts of the polysilane.

### EXAMPLE 2

### Preparation of Material for High Refractive Index Glass

A material for a high refractive index glass was prepared in the same manner as in Example 1 except that the amount of the zircon oxide nanoparticle dispersion used was changed to 840.3 parts. In this case, the amount of zircon oxide used was 284.4 parts with respect to 100 parts of the polysilane.

### EXAMPLE 3

### Production of High Refractive Index Glass and Formation of Minute Pattern

A 5 mm×5 mm sample piece was cut out from a quartz substrate, sufficiently washed, and used as a substrate. The washing was performed by: subjecting the sample piece to ultrasonic cleaning in acetone for 3 minutes; and leaving the resultant to stand in a UV ozone cleaner for 10 minutes. The surface of the substrate was subjected to spin coating with the material for a high refractive index glass obtained in Example 1 at 5,000 rpm for 40 seconds, whereby a coating film having a thickness of about 2 μm was obtained. The substrate coated with the material for a high refractive index glass was prebaked at 80° C. for 5 minutes.

Next, a mold formed of Si on which line and space (L & S) patterns with multiple sizes had been formed was pressed to the above coating film at a temperature of 80° C. and a pressure of 4 MPa for 1 minute for imprinting. In the L & S patterns of the mold used in this example, a line-to-space ratio L:S was 1:1, and a line (space) size was 250 nm to 25 μm between which there was a difference of two orders of magnitude. Further, the coating film was irradiated with ultraviolet light (light source: ultra-high pressure mercury lamp, output: 250 W, irradiation time: about 3 minutes) from the substrate side in a state where the mold was contacted by press with the coating film, whereby the coating film was almost completely photooxidized. Next, the mold was pulled up vertically and released. The reverse pattern of the mold was favorably transferred and fixed onto the surface of the coating film (glass) after the mold had been released.

Further, the surface of the pattern was subjected to an oxygen plasma treatment. Conditions for the oxygen plasma treatment were as follows: an oxygen flow of 800 cc, a chamber pressure of 10 Pa, an irradiation time of 5 minutes, and an output of 100 W. Next, the resultant was irradiated with ultraviolet light from the pattern surface side (the side to which the mold had been pressed). The resultant was irradiated with ultraviolet light by using a UV ozone cleaner in the presence of ozone. Here, the resultant was irradiated with ultraviolet light for 30 minutes at an oxygen flow of 0.5 L/min. Finally, the substrate/pattern obtained as described above was postbaked on a hot plate at 300° C. for 5 minutes. As described above, minute pattern was formed on the substrate simultaneously with the formation of the high refractive index glass.

The glass on which the minute pattern had been formed was evaluated for the above items (1) to (7). Table 2 shows the results together with the results of Example 4 and Comparative Example 1 to be described later.

TABLE 2

| | | | Comparative |
|---|---|---|---|
| | Example 3 | Example 4 | Example 1 |
| Refractive | 1.60 | 1.61 | 1.56 |
| index | | | |
| Transparency | Good | Good | Good |
| Hardness (HV) | 120 | 144 | 77 |
| Pattern | Good | Moderate | Good |
| formability | | | |
| Surface | Good | Good | Good |
| roughness | | | |
| Heat resistance | Good | Good | Good |
| Chemical | Good | Good | Good |
| resistance | | | |
| (washing with | | | |
| acetone) | | | |
| (immersion in | Good | Good | Good |
| chemical) | | | |

### EXAMPLE 4

### Production of High Refractive Index Glass and Formation of Minute Pattern

A minute pattern was formed on a substrate simultaneously with the formation of a high refractive index glass in the same manner as in Example 3 except that the material for a high refractive index glass obtained in Example 2 was used. The glass on which the minute pattern had been formed was evaluated for the above items (1) to (7). Table 2 shows the results.

### COMPARATIVE EXAMPLE 1

A composition was prepared in the same manner as in Example 1 except that the zircon oxide nanoparticle dispersion was not used. A minute pattern was formed on a substrate simultaneously with the formation of a high refractive index glass in the same manner as in Example 3 except that the composition was used. The glass on which the minute pattern had been formed was evaluated for the above items (1) to (7). Table 2 shows the results.

As is apparent from Table 2, the use of metal oxide nanoparticles can: increase a refractive index to a desired range (1.60 or higher); and make a hardness much larger than that of the Comparative Example.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A material for a high refractive index glass, comprising:
a polysilane;
a silicone compound; and
metal oxide nanoparticles.

2. A material for a high refractive index glass according to claim 1, wherein the polysilane comprises a branched polysilane.

3. A material for a high refractive index glass according to claim 1, wherein the polysilane and the silicone compound are contained at a weight ratio of 80:20 to 5:95.

4. A material for a high refractive index glass according to claim 1, wherein the metal oxide nanoparticles are formed of at least one metal oxide selected from the group consisting of zircon oxide, titanium oxide, and zinc oxide.

5. A material for a high refractive index glass according to claim 1, wherein the metal oxide nanoparticles have an average particle diameter of 1 nm to 100 nm.

6. A material for a high refractive index glass according to claim 1, wherein the metal oxide nanoparticles are contained at a ratio of 50 parts by weight to 500 parts by weight with respect to 100 parts by weight of the polysilane.

7. A high refractive index glass obtained by oxidizing the material for a high refractive index glass according to claim 1.

8. A high refractive index glass according to claim 7, wherein the oxidation is performed by irradiating the material with an energy ray.

9. A high refractive index glass according to claim 7, which has refractive index of 1.60 or higher, hardness of 120 HV or higher, and light transmittance in a visible region of 90% or higher.

10. A method of forming a minute pattern on a high refractive index glass, comprising the steps of:
applying, to a substrate, the material for a high refractive index glass according to claim 1;
pressing a mold on which a predetermined minute pattern has been formed to the material for a high refractive index glass which has been applied to the substrate;
irradiating the material for a high refractive index glass with an energy ray from a side of the substrate while the mold is contacted by press with the material for a high refractive index glass;
releasing the mold; and
irradiating the material for a high refractive index glass with an energy ray from a side to which the mold has been pressed.

11. A method of forming a minute pattern on a high refractive index glass according to claim 10, further comprising the step of irradiating oxygen plasma after the mold has been released.

12. A method of forming a minute pattern on a high refractive index glass according to claim 10, wherein the step of pressing is performed at about room temperature.

13. A method of forming a minute pattern on a high refractive index glass according to claim 10, further comprising the step of heating the material for high refractive index glass material after irradiating the energy ray from the side to which the mold has been pressed.

14. A method of forming a minute pattern on a high refractive index glass according to claim 13, wherein the step of heating is performed at 150 to 450° C.
